(19) United States
(12) Patent Application Publication
(10) Pub. No.: US 2005/0281176 A1
(43) Pub. Date: Dec. 22, 2005

(54) Optical recording medium

(76) Inventor: Chao Ping Lai, Shin-Chuang City (TW)

Correspondence Address: BIRCH STEWART KOLASCH & BIRCH, PO BOX 747, FALLS CHURCH, VA, 22040-0747, US

(21) Appl. No.: 10/868,825

(22) Filed: Jun. 17, 2004

(51) Int. Cl. G11B 7/00; G11B 7/24

(52) U.S. Cl. 369/272.1; 369/275.1; 369/275.4

(57) ABSTRACT

An optical recording medium includes a substrate, a plurality of grooves, a plurality of lands and a plurality of land protrusions. The grooves are formed on the substrate, and the lands are formed between the grooves. The land protrusions are formed on the lands.

### BACKGROUND OF THE INVENTION

1. Field of Invention

The invention relates to an optical recording medium and, in particular, to an optical recording medium, which includes a plurality of land protrusions.

2. Related Art

Accompanying the age of information and multimedia, the present electronic products have increased needs on the storage density and capacity of storage media. The storage media are, for example, the write once recordable digital versatile disc (DVD-R), the rewritable digital versatile disc (DVD-RW), and the likes.

With reference to FIG. 1, a conventional DVD 1 includes a substrate 11, a plurality of grooves 12, a plurality of lands 13 and a plurality of land pre-pits 14. The grooves 12 are formed on the substrate 11, and the lands 13 are formed between the grooves 12.

The land pre-pits 14 are positioned in the lands 13 for addressing, storing time codes or synchronizing. In general, after the DVD 1 is burned to record data, the land pre-pits 14 are tested to obtain a measuring value representing the characteristics of the land pre-pits 14. The measuring value is an aperture ratio (AR). When the signals carried by the land pre-pits 14 are shown on the oscilloscope, the aperture ratio is the maximum of the amplitude shown on the oscilloscope over the minimum thereof. If the aperture ratio is too small, the disc driver may fail to detect the synchronization positions during reading the DVD 1.

Referring to FIG. 2, the DVD 1 may further include a recording layer 15 and a reflecting layer 16. The recording layer 15 is disposed on the substrate 11, and the reflecting layer 16 is disposed on the recording layer 15. The material of the recording layer 15 could be an organic dye or a phase change material, and is formed by way of spin coating or sputtering.

During the manufacturing processes, the organic dye or the phase change material, however, may be deposited into the land pre-pits 14. Therefore, the laser beam 17 for burning the disc can irradiate not only the grooves 12, but also the land pre-pits 14. The material deposited in the land pre-pits 14 would then absorb the energy, so that the signals carried by the land pre-pits 14 are changed accordingly. For example, the aperture ratio may become smaller, which results in problems when using the pick-up head to trace the tracks.

It is therefore a subjective to provide an optical recording medium, which can solve the problem of tracing caused by the deposited recording material in the land pre-pits.

### SUMMARY OF THE INVENTION

In view of the foregoing, the invention is to provide an optical recording medium, which can solve the problem of tracing caused by the deposited recording material in the land pre-pits.

To achieve the above, the optical recording medium of the invention includes a substrate, a plurality of grooves, a plurality of lands and a plurality of land protrusions. The grooves are formed on the substrate, and the lands are formed between the grooves. The land protrusions are formed on the lands.

As mentioned above, the optical recording medium of the invention includes the land protrusions formed on the lands, which are for addressing, storing time codes or synchronizing. Comparing with the prior art, when applying the recording material on the disc, the land protrusions would not be filled with the recording material. Therefore, when using the laser beam to burn the disc, the signals carried by the land protrusions do not be changed. Accordingly, the problems of using the pick-up head to trace the tracks would not occur.

### BRIEF DESCRIPTION OF THE DRAWINGS

The invention will become more fully understood from the detailed description given hereinbelow illustration only, and thus is not limitative of the present invention, and wherein:

FIG. 1 is a schematic view showing part of the conventional disc;

FIG. 2 is a schematic sectional view showing part of the conventional disc;

FIG. 3 is a schematic view showing part of an optical recording medium according to a preferred embodiment of the invention; and

FIG. 4 is a schematic sectional view showing part of the optical recording medium according to the embodiment of the invention.

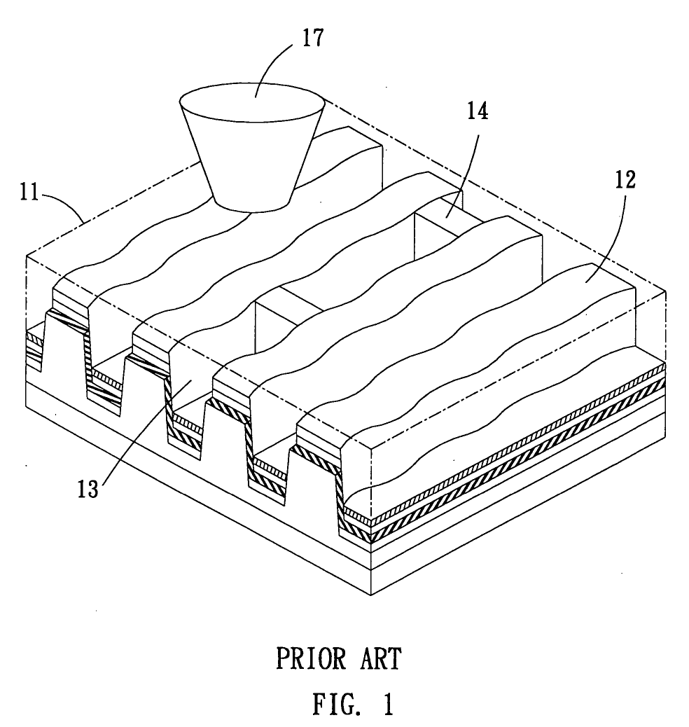

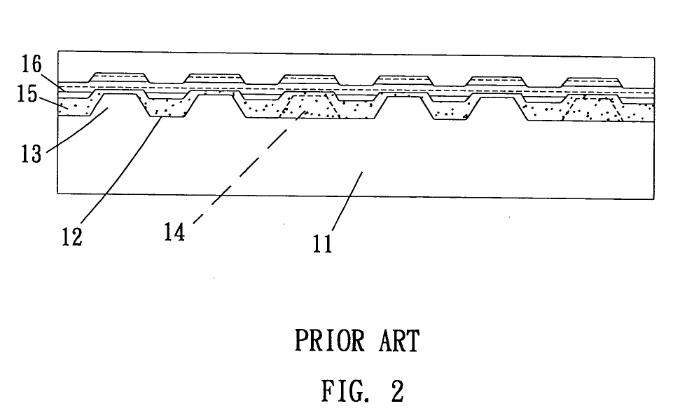

### DETAILED DESCRIPTION OF THE INVENTION

The present invention will be apparent from the following detailed description, which proceeds with reference to the accompanying drawings, wherein the same references relate to the same elements.

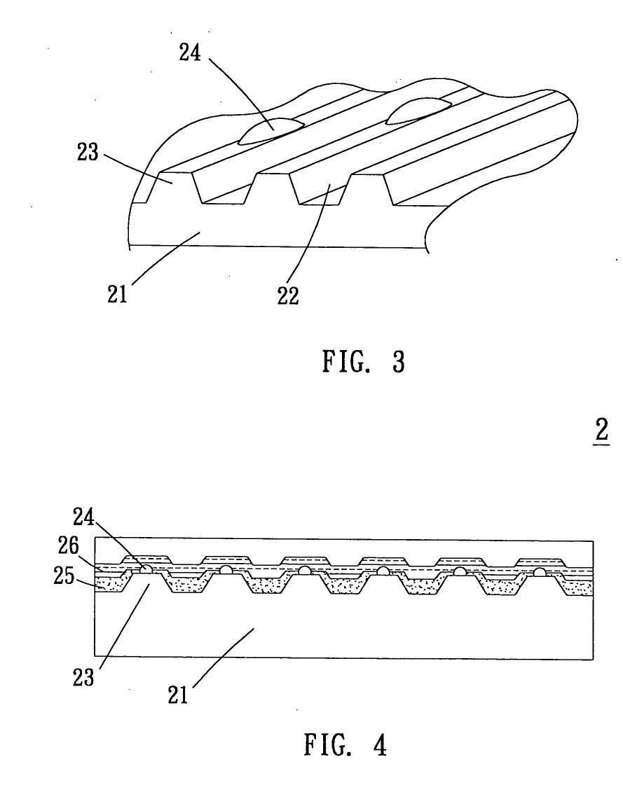

With reference to FIG. 3 and FIG. 4, an optical recording medium 2 according to the embodiment of the invention includes a substrate 21, a plurality of grooves 22, a plurality of lands 23, and a plurality of land protrusions 24. The substrate 21 is transparent and is disc-shaped. The substrate 21 can be made of a polycarbonate compound. The grooves 22 are formed on the substrate 21. The lands 23 are formed between the grooves 22, so the grooves 22 are alternate with the lands 23. The land protrusions 24 are formed on the lands 23 for addressing, storing time codes or synchronizing.

The optical recording medium 2 can be a write once recordable compact disc (CD-R), a rewritable compact disc (CD-RW), a write once recordable digital versatile disc (DVD-R), or a rewritable digital versatile disc (DVD-RW). Alternatively, the optical recording medium 2 can be a high density optical disc.

The optical recording medium 2 further includes a first recording layer 25 and a first reflecting layer 26. In the embodiment, the first recording layer 25 is disposed on the substrate 21, and the first reflecting layer 26 is formed on the first recording layer 25. The material of the first recording layer 25 can be an organic dye or an inorganic material, which is formed on the substrate 21 by spin coating. In addition, the first recording layer 25 can be made of a phase change material, which is formed on the substrate 21 by sputtering or evaporating.

Since the optical recording medium 2 of the embodiment includes the land protrusions 24 formed on the lands 23, the material of the first recording layer 25, such as the organic dye or phase change material, would not cover the land protrusions 24 when forming the first recording layer 25. Therefore, when using the laser beam to burn the medium 2, the signals carried by the land protrusions 24 would not be changed. In other words, the aperture ratio (AR) of the land protrusions 24 is about 1, which never results in the problems of using the pick-up head to trace the tracks.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An optical recording medium, comprising:
a substrate;
a plurality of grooves, which are formed on the substrate;
a plurality of lands, which are formed between the grooves; and
a plurality of land protrusions, which are formed on the lands.

2. The optical recording medium of claim 1, further comprising:
a first recording layer, which is disposed on the substrate.

3. The optical recording medium of claim 2, wherein the first recording layer is formed by spin coating.

4. The optical recording medium of claim 3, wherein the material of the first recording layer comprises an organic dye.

5. The optical recording medium of claim 3, wherein the material of the first recording layer is an inorganic material.

6. The optical recording medium of claim 2, wherein the first recording layer is formed by sputtering or evaporating.

7. The optical recording medium of claim 6, wherein the material of the first recording layer is a phase change material.

8. The optical recording medium of claim 1, wherein the substrate is made of a polycarbonate compound.

9. The optical recording medium of claim 2, further comprising:
a first reflecting layer, which is disposed on the first recording layer.

10. The optical recording medium of claim 1, wherein the optical recording medium is a write once recordable digital versatile disc (DVD-R).

11. The optical-recording medium of claim 1, wherein the optical recording medium is a rewritable digital versatile disc (DVD-RW).
